(19) United States
(12) Patent Application Publication
(10) Pub. No.: US 2007/0260903 A1
(43) Pub. Date: Nov. 8, 2007

(54) MULTIMEDIA REPRODUCTION SYSTEM AND CONTROL METHOD THEREOF

(75) Inventors: Chun-Lung Liu, Hualien Hsien (TW); Wei-Hung Huang, Hsinchu City (TW); Shih-Hao Chen, Hsinchu City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: MEDIATEK INC., Hsin-Chu (TW)

(21) Appl. No.: 11/382,100

(22) Filed: May 8, 2006

(51) Int. Cl. G06F 1/00

(52) U.S. Cl. 713/310

(57) ABSTRACT

A multimedia reproduction system and control method thereof. A plurality of operating modes are associated with a plurality of command sets. The plurality of command sets are mapped to a plurality of control signal subsets. It is determined to which of the command sets a received control signal belongs in order to enter an operating mode associated with the determined command set and present a relevant content item for the operating mode.

### BACKGROUND

A large amount of analog or digital data can be stored on a recording medium, such as a videodisk or hard disk. In the past, display of that information, even with professional systems, has been a time-consuming task, particularly if the information was to be presented on a small display apparatus. Small display apparatuses do not provide an adequate display area for presentation of the control menu or additional information to facilitate control of the system. Typically, a control method with more than two operating modes is required for the vehicle or portable multimedia playback device. When switching between modes using the conventional control method redundant operation is unavoidable. Thus, the user interface of the conventional control method is not user-friendly.

FIG. 1 is a flowchart of a conventional method of controlling a multimedia reproduction system. A multimedia reproduction system includes a plurality of operating modes. For example, the system can be a digital versatile disk (DVD) playback system combined with a TV tuner. In this system, at least a first operating mode (mode M10) for title playback and a second operating mode (mode M20) for channel tuning are provided. One operating mode can be selected from these two operating modes. After modes selection, the system provides the functions corresponding to the selected operating mode. If title playback mode is selected (mode M10), the system can play back the stored content by reading from the DVD disk. If the channel tuning mode is selected (mode M20), the system tunes to one selected channel to receive broadcast content (step S33).

In the conventional control method, if a user wants to switch the operating mode from the initial status (not shown) or switch the operating mode from the first mode to the second mode, a stop key must be pressed (step S31) to notify the system. After receiving the notification, the system will halt operations of the first operating mode in order to prepare to switch to the second operating mode. The system will then switch from the first operating mode to the second operating mode and enable the system to received further operations corresponding to the second operating mode (step S33). In the second mode, direction keys, such as up and down keys, can be used to select a desired channel.

If the stop key is not pressed (step S31) first, channel tuning operations (step S33) cannot be performed when in the first operating mode. As previously described to exit mode from the second operating mode and enter the first operating mode, a play key must be pressed again (step S32) to notify the system that there will be a mode changing operation. Changing the mode first and then selecting a channel after the mode change is considered inconvenient.

### SUMMARY

A multimedia reproduction system and control method thereof is provided. The multimedia reproduction system comprises a plurality of operating modes. The control system for the multimedia reproduction system enables operating steps to be combined, thereby increasing system efficiency.

An exemplary embodiment of a multimedia reproduction system and control method thereof comprises: a means for associating a plurality of operating modes with a plurality of command sets; means for mapping the plurality of command sets to a plurality of control signal subsets, wherein a control signal subset is selected from a group of control signals; means for determining to which command set a received control signal belongs; means for entering an operating mode associated with the determined command set, and means for presenting a relevant content item for the operating mode.

In another embodiment of a multimedia reproduction system and control method thereof comprises: an associating step for associating the plurality of operating modes with a plurality of command sets; a mapping step for mapping the plurality of command sets to a plurality of control signal subsets, wherein a control signal subset is selected from a group of control signals; a determining step for determining to which of the command sets a received control signal belongs; an entering step for entering an operating mode associated with the determined command set, and a presenting step for presenting a relevant content item for the operating mode.

These and other objectives of the present embodiment will no doubt become obvious to those of ordinary skill in the art after reading the following detailed description of the preferred embodiment that is illustrated in the various figures and drawings.

### DESCRIPTION OF THE DRAWINGS

The invention can be more fully understood by reading the subsequent detailed description and examples with references made to the accompanying drawings, wherein:

FIG. 1 is a flowchart of a conventional multimedia reproduction system and control method thereof.

FIG. 2 is a flowchart of an embodiment of a multimedia reproduction system control method thereof.

FIG. 3 is a relevant content item presented in playback mode in an embodiment of a multimedia reproduction system.

FIG. 4 is a relevant content item presented in playback mode in another embodiment of a multimedia reproduction system.

FIG. 5 is a relevant content item presented in the tuner mode in an embodiment of a multimedia reproduction system.

FIG. 6 is a relevant content item presented in the tuner mode in another embodiment of a multimedia reproduction system.

FIG. 7 is a diagram of showing the mapping between command sets with control signal subsets, wherein the command sets are associated with operating modes.

FIG. 8 is a diagram of showing the mapping between control signals with control signal subsets.

FIG. 9 is a block diagram of an embodiment of a multimedia reproduction system and control method thereof.

### DETAILED DESCRIPTION

FIG. 2 is a flowchart of an embodiment of a multimedia reproduction system and control method thereof. The multimedia reproduction system can provide a DVD playback sub-system and a TV receiving sub-system. The DVD playback system can play back content stored on the DVD disk and present broadcast content received by the TV receiving system using the tuner to select the desired channel in analog or digital format. The DVD playback system can comprise a plurality of command sets. Each command set has corresponding functions. For example, the DVD playback system can have forwarding, time shifting, setting, and other command sets. One of the plurality of command sets is described in the following. The forwarding command set comprises a plurality of commands including, fast forwarding, slow forwarding, double speed forwarding and others.

The multimedia reproduction system further comprises an input peripheral for receiving the control signal triggered by user, such as key presses. A remote control is given as an example of an input peripheral. A remote control has a plurality of keys disposed thereon. The keypad comprises a plurality of keys corresponding to various functions, including direction keys, power keys, play and stop keys and similar. Each key, when pressed, emits a unique electronic signal. The signal is transmitted from the remote control via the IR transmitter/receiver to the multimedia reproduction system. The system recognizes to which group the received signal belongs.

When the playback mode is selected, the system can play back the stored content by reading from the DVD disk. The system associates command sets with the playback mode. The system then knows which command set can be enabled within the playback mode.

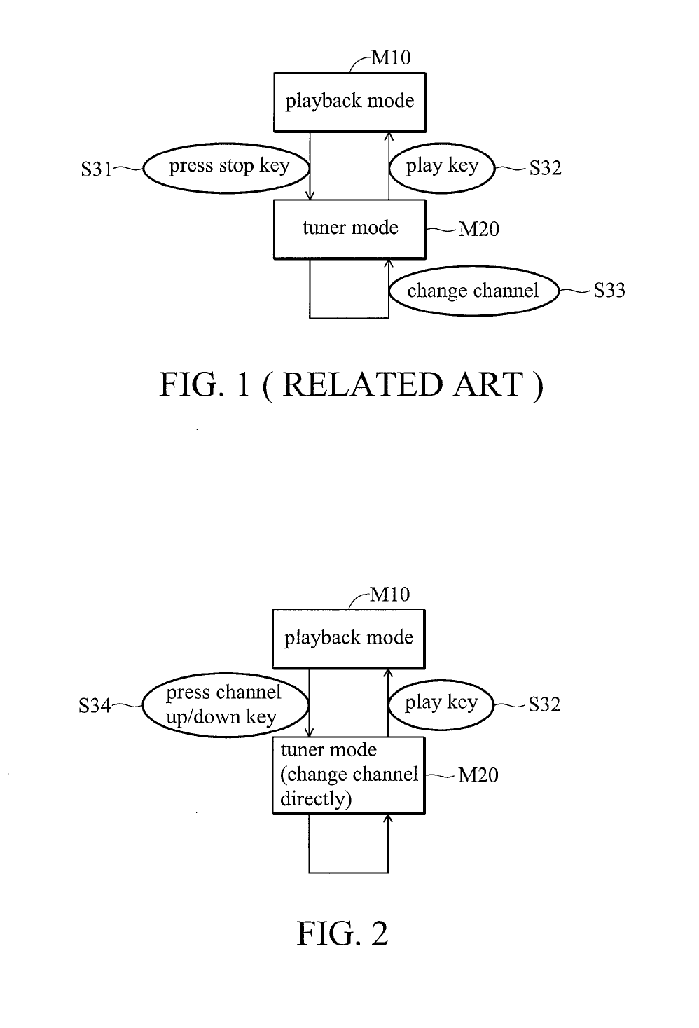

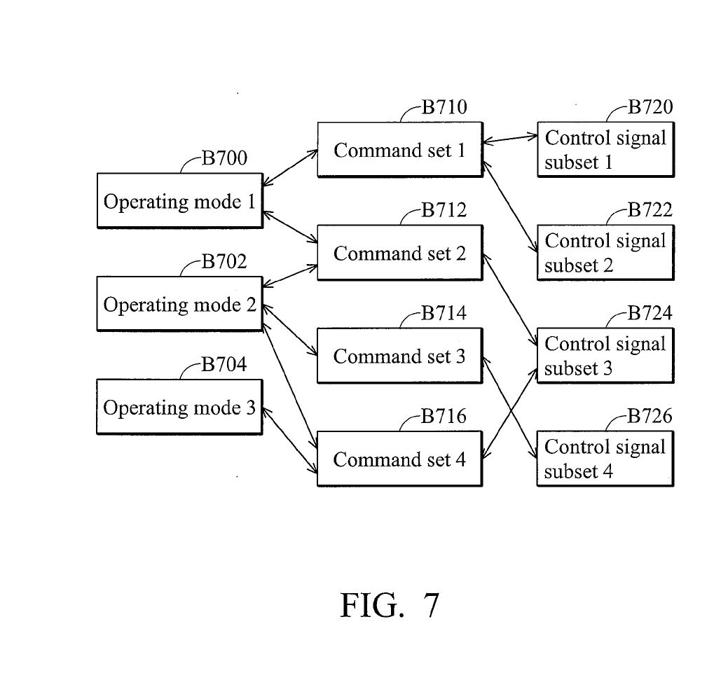

In the embodiment of FIG. 2, the system is operating in playback mode. In practice, a user may be browsing the DVD disk, but, suddenly wants to watch TV. In the conventional control method, stop key must first be pressed to switch from playback mode to tuning mode. The invention eliminates this need. Referring to steps S31 and S33 of the conventional flowchart of FIG. 1, the user must press a stop key (step S31) to send a notification to the system. The system will then acknowledge that there a mode change operation will occur. Then, operation mode is changed. In the invention, the user starts the channel selection by simply pressing the direction key on the remote control. Comparing FIG. 2 with FIG. 1, in FIG. 2, the user does not need to press the stop key. The invention combines step S31 with step S33 into step S34. In step S34, the user directly presses the direction key. Thereafter, the system can check the association between the control signal and the operating mode. A detailed description of the steps of determining the association is provided in FIG. 7. The system discovers that the control signal is related to the direction information and the direction information is only related to the tuner mode. This indicates that the user wants to exit the present operating mode and enter a new operating mode. In the FIG. 2, step 34 replaces steps S31 and S33. The user can directly input the direction signal which is only related to the tuner mode greatly enhancing convenience and system operation efficiency. The playback mode and tuner mode are provided for description only and are not intended to be limitative. The operating mode is not limited to these two modes. In other modes, the same steps can also be employed to enhance system operation efficiency.

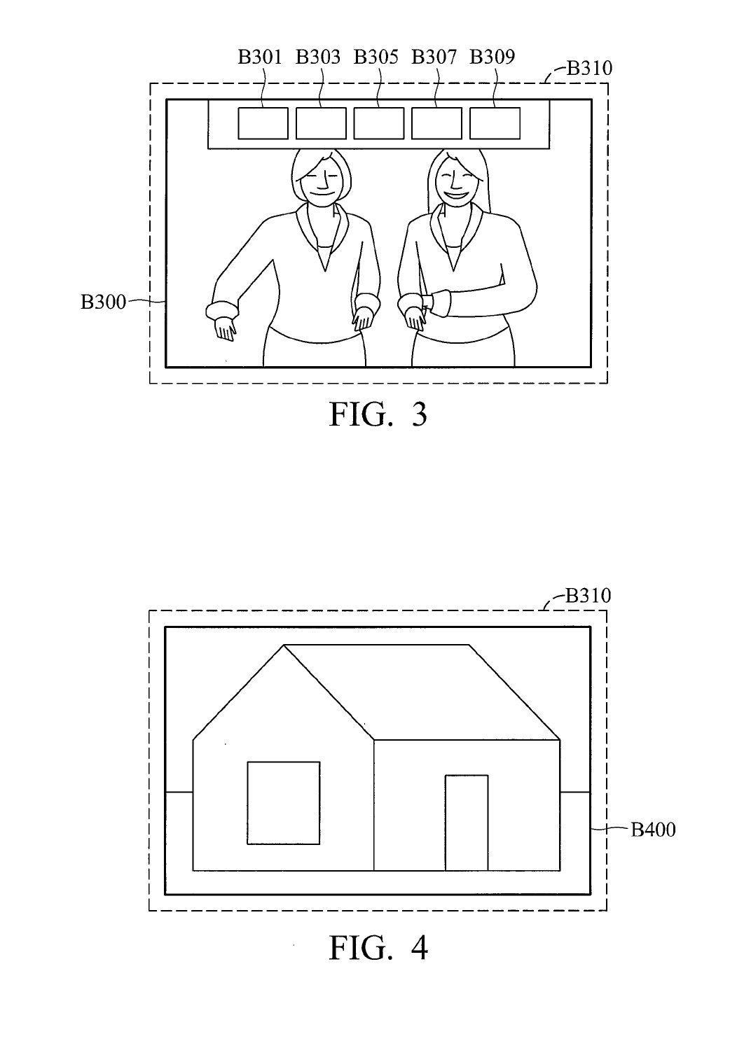

FIG. 3 shows a relevant content item presented in playback mode. The relevant content item referred hereafter can be reproduced from digital audio, digital video, or digital video-and-audio signal. The content of the digital video disk is shown in the center of the display area (B300). The command menu is displayed at the top of the display area. The command menu comprises command items (B301, B303, B305, B307, and B309). Each command item corresponds to a different function. When a command item is selected, the display area may present the corresponding function help (not shown). Command item B301 corresponds to the title selection, this item must be selected to change the title presented in the center of the display area. One embodiment may provide a remote control, which can be used to input the control signal to select the desired function shown at the top of the display area. In this embodiment, the playback mode has only five command items. For each operating mode, which has its specific command items, a command item can be associated with more than one operating mode. Time-shifting is a universal command suitable for many operating modes. In the playback mode, it can be used to shift the content of the title to be played. Meanwhile, Time-shifting can also be used in the tuner mode for playing back the content received by the tuner. In the other words, the relationships between the operating mode and the command items are not one-to-one. The system designer can setup the relationship according to design requirements. In one of the operating modes, command set to be enabled is predetermined. A user can activate the function belonging to the playback mode, and the relevant content item is presented in the display area when the system is in the playback mode.

FIG. 4 is a relevant content item presented in the tuner mode. The content (B400) received from the tuner is shown in the center of the display area (B300). In this mode, a command menu is not presented in the display area. The system, however, still has the ability to receive control signals from an input device, for example, a remote control. When a user inputs a control signal corresponding to the tuner mode, the system still can perform the indicated function.

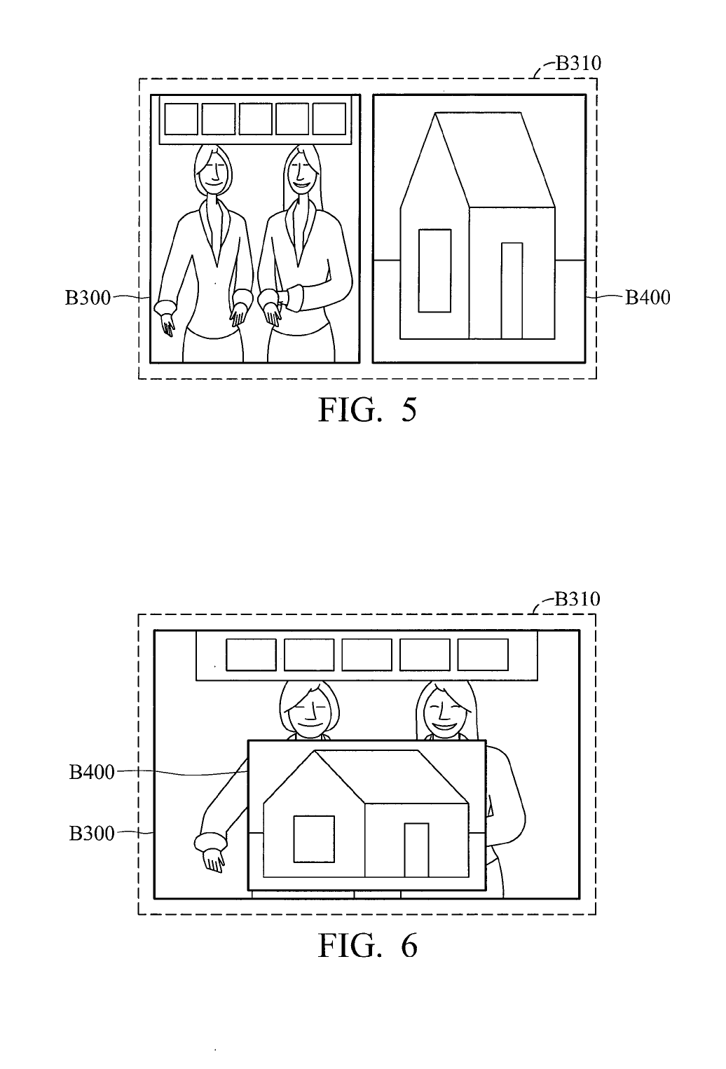

FIG. 5 shows a relevant content item presented in the tuner mode. After receiving the direction signal indicating the mode change, the system will switch from the first mode to the second mode. The system may arrange the output form of presentation for the previous operating mode and the operating mode. Exemplary embodiments of arranging a form is shown in the following descriptions. In the previous figure (FIG. 2 and FIG. 3), the system only presented a relevant content item relevant to the entered mode. With the advent of wide screen televisions, however, many new features have been made possible. A wide screen television may have a format display ratio, for example, of 16 horizontal units by 9 vertical units, as opposed to the traditional television display ratio of 4×3. One feature made available by the wide screen display ratio is the picture-outside-picture (POP). POP displays one or more smaller video images in an otherwise unused side area of the 16×9 display area, simultaneously with display of a larger 4×3 image. Since the wide screen television has larger viewable area, a system can present the relevant content item of the previous operating mode and the relevant content item of the current operating mode in the same display area (B310). In FIG. 5, the left side of the display area is presenting the relevant content item of the previous mode (B300) and the right side of the display area is presenting the relevant content item of the current mode (B300). The system can have multiple presentation methods for emphasizing the visual effects for each side of the display. These include fade in, fade out, fade in/out, undulation, and slide. Slide includes in, out, loop, up and down. Undulation refers to transition between colors. For animation, a group of still pictures are created in a display sequence. Text is made graphic by creating an image of text and font objects with effects applied. Font objects are parameters that constitute selected font effects, including type, point size, color. A background object is the canvas on which a document is painted or created. In order to enrich the visible enjoyment, one of the said effects can be applied to the display area. The system can use the effects to indicate to the user which side is presenting the relevant content item of the entered operating mode. The content of the left side (previous mode) can also be frozen in order to indicate that the left side is presenting a still image after switching to the entered operating mode (right side). The right side is presenting the live video alive but the left side is not.

FIG. 6 shows another relevant content item presented in tuner mode. As shown in FIG. 5, another feature made available by the wide screen display ratio is picture-in-picture (PIP). B400 is the relevant content item of the current operating mode. B300 is the relevant content item of the previous operating mode. PIP allows display area of B300 to be presented in display area B400. It may be advantageous both sources in to share the same display in terms of presentation, but the source have different areas in terms of size. The B400 is called the foreground and the B300 is called the background. As shown in the figure, the content item presented in the foreground is more attractive than that presented in the background to attract a user's gaze.

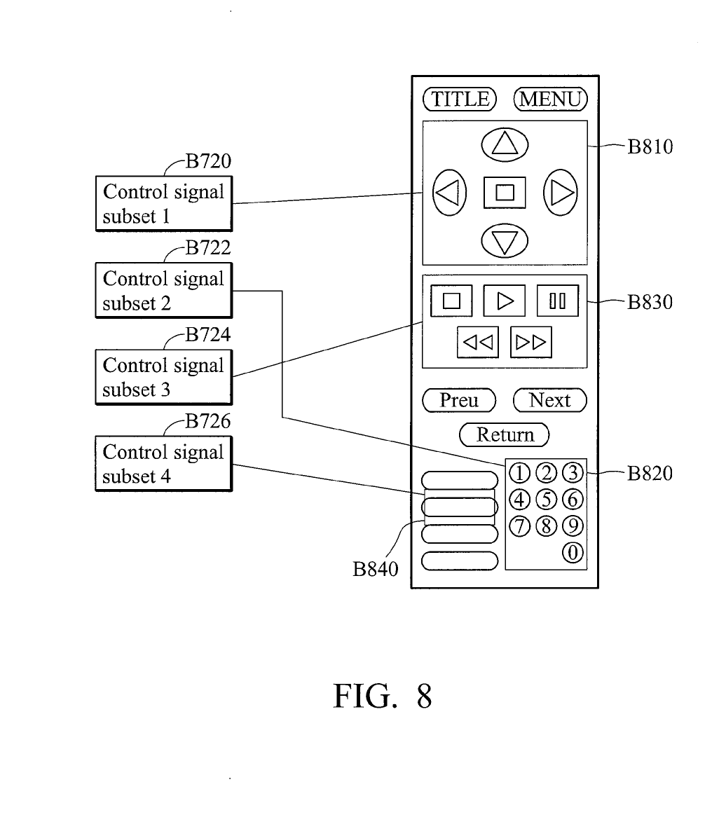

FIG. 7 and FIG. 8 illustrate the association between the operating modes and the command sets. Please refer first to FIG. 7. Since a system may comprise more than two operating modes, it is assumed that the system comprises three operating modes (B700, B702, and B704). Each mode can be performed identically. The elements of the second column of FIG. 7 are the command sets (B710, B712, B714, and B716) of the system. Each command set controls a unique function such as fast forwarding. A Fast forward command set may comprise two control signal subsets. One of the control signal subsets can be a pair of direction control signals (left/right). The other one can be a group of functional control signals (normal speed/double speed). The two kinds of control signals belong to different control signal subsets. Thus, one command set may be associated with more than one of operating mode. This means the command set can be shared between different operating modes. Control signal subset (B720, B722, B724, and B726) is a pair or a group of control signals. Please refer to FIG. 8. As shown in FIG. 8, control signal subset 1 (B720) is a group of direction signals (B810), control signal subset 2 (B722) is the numerical control signals (B820), control signal subset 3 (B724) is the playback control signal (B830). As with other described embodiments, when a user inputs the direction signal, the system will recognize that the signal belongs to the control signal subset 1 which is mapped to the command set 1. The control signal is used to trigger one function of command set 1 to perform the corresponding operation. FIG. 7 shows command set 1 which belongs to operating mode 1.

In practice, if the system is in operating mode 2, the system will discover that there is no relationship between the control signal subset 1 and operating mode 2, when a user inputs the direction signal. This operation indicates to the system that the user wants to perform a function included in operating mode 1. Thus, the system will switch to operating mode 1 without the stop key to be pressed as required by conventional implementations. A question may arise here. If the user presses the key unintentionally, the system can determine via a provided anti-accident method to determine that whether or not the user wants to switch modes. If system detects that the user presses the key unintentionally, then, the system returns to a previous operating mode. One embodiment of the anti-accident method arbitrates whether an operating mode can be entered contingent upon an effective period of the received control signal. The effective period is required to be sustained for a predetermined duration. Another embodiment of the anti-accident method arbitrates whether the operating mode can be entered contingent upon a number of consecutive inputs of the same control signal, wherein the control signal is required to be input within a predetermined duration.

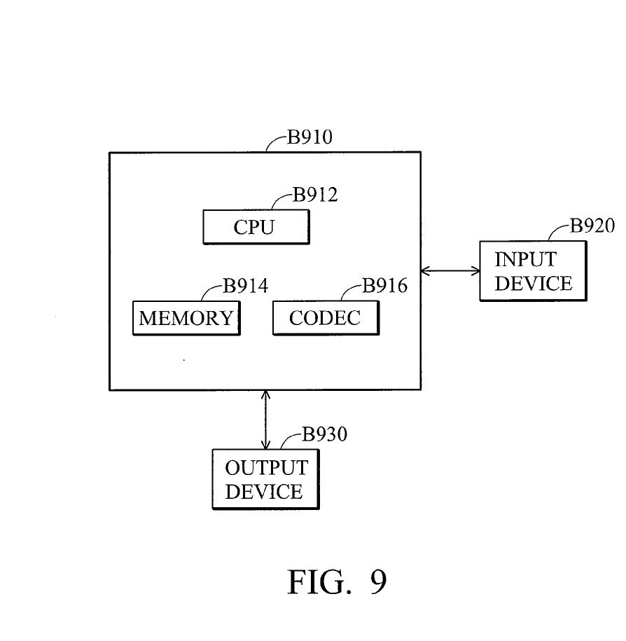

Implementation of the above described system may be accomplished by any variety of software/firmware/hardware means. In one embodiment (shown in FIG. 9), the CPU (B912) is programmed to associate the plurality of operating modes with a plurality of command sets, mapping the plurality of command sets to a plurality of control signal subsets, wherein a control signal subset is selected from a group of control signals, determining to which of the command sets a received control signal belongs, or entering an operating mode associated with the determined command set. The memory (B914) is used to store the association/mapping table between operating modes/command sets/control signal subsets. The input device (B920) is used to receive and transmit the input signal to the main system (B910) for execution of said process. The CODEC (B916) is used to process the multimedia signal which is relevant to each operating mode. Finally, the output device (B930) is used to present the processed content from the CODEC (B916) and the CPU (B912).

Those skilled in the art will readily observe that numerous modifications and alterations of the device and methods may be made while retaining the teachings of the invention. Accordingly, the above disclosure should be construed as limited only by the metes and bounds of the appended claims.

What is claimed is:

1. A method of controlling a multimedia reproduction system having a plurality of operating modes, the method comprising the steps of:
associating the plurality of operating modes with a plurality of command sets;
mapping the plurality of command sets to a plurality of control signal subsets, wherein a control signal subset is selected from a group of control signals;
determining to which of the command sets a received control signal belongs;
entering an operating mode associated with the determined command set; and
presenting a relevant content item for the operating mode.

2. The method of claim 1, further comprising:
accepting the received control signal in a previous operating mode; and
arranging a form of presentation for the previous operating mode and the operating mode.

3. The method of claim 2, further comprising:
presenting a content item relevant to the previous operating mode in a background; wherein the relevant content item for the operating mode is presented in a foreground.

4. The method of claim 1, wherein the received control signal comprises direction information for selecting the operating mode.

5. The method of claim 1, further comprising:
arbitrating whether the operating mode can be entered contingent upon a number of received control signals, wherein the number is set to at least one.

6. The method of claim 1, further comprising:
arbitrating whether the operating mode can be entered contingent upon an effective period of the received control signal, wherein the effective period is sustained for a predetermined duration.

7. The method of claim 1, further comprising:
returning to a previous operating mode if another control signal is not received within a predetermined duration during the presentation for the operating mode.

8. The method of claim 1, wherein the relevant content item is reproduced from digital audio, digital video, or digital video-and-audio signal.

9. A multimedia reproduction system comprising:
means for associating a plurality of operating modes with a plurality of command sets;
means for mapping the plurality of command sets to a plurality of control signal subsets, wherein a control signal subset is selected from a group of control signals;
means for determining to which of the command sets a received control signal belongs;
means for entering an operating mode associated with the determined command set; and
means for presenting a relevant content item for the operating mode.

10. The system of claim 9, further comprising:
means for arranging a form of presentation for the current operating mode and a previous operating mode in which the received control signal is accepted.

11. The system of claim 10, wherein the means of presentation is further operative to present a content item relevant to the previous operating mode in a background and the relevant content item for the operating mode in a foreground.

12. The system of claim 9, wherein the received control signal comprises direction information for selecting the operating mode.

13. The system of claim 9, further comprising:
means for arbitrating whether the operating mode can be entered contingent upon a number of received control signals, wherein the number is set to at least one.

14. The system of claim 9, further comprising:
means for arbitrating whether the operating mode can be entered contingent upon an effective period of the received control signal, wherein the effective period is sustained for a predetermined duration.

15. The system of claim 9, further comprising:
means for returning to a previous operating mode if another control signal is not received within a predetermined duration during the presentation.

16. The system of claim 9, wherein the relevant content item is reproduced from digital audio, digital video, or digital video-and-audio signal.

17. A method of controlling a DVD recorder having a plurality of operating modes, the method comprising the steps of:
receiving a direction signal in a first operating mode;
determining whether a second operating mode can be entered contingent upon the received direction signal;
entering the second operating mode from the first operating mode; and
presenting a relevant content item for the second operating mode.

18. The method of claim 17, wherein the first operating mode is a playback mode.

19. The method of claim 18, wherein the second operating mode is a turner mode.

20. The method of claim 19, further comprising:
returning to the playback mode if another control signal is not received within a predetermined duration during the presentation of the tuner mode.
